(19) United States
(12) Patent Application Publication
(10) Pub. No.: US 2006/0219185 A1
(43) Pub. Date: Oct. 5, 2006

(54) Collapsible cat condo

(76) Inventor: Robert A. Larson, Fort Collins, CO (US)

Correspondence Address: JAMES RAY & ASSOCIATES, 2640 PITCAIRN ROAD, MONROEVILLE, PA, 15148, US

(21) Appl. No.: 11/393,473

(22) Filed: Mar. 30, 2006

Related U.S. Application Data
(60) Provisional application No. 60/666,352, filed on Mar. 30, 2005.

(51) Int. Cl. A01K 1/03

(52) U.S. Cl. 119/482

(57) ABSTRACT

A pet enclosure for an outdoor area capable of being collapsed into a relatively small package for storage when not in use. The said pet enclosure includes a first plurality of relatively straight pieces of preselected structural members having a first predetermined shape and length. A plurality of connecting members having a second predetermined shape which is at least one of small enough to fit inside an end portion of one of such relatively straight pieces and large enough to receive an end portion of one of the relatively straight pieces therein. These connectors allow collapsing of the pet enclosure. A door framework engageable with at least one straight piece. A set of connectors for the door framework. A second plurality of relatively straight pieces of structural members for forming a roof and a covering for such framework.

### CROSS REFERENCE TO RELATED APPLICATIONS

This application is closely related to and claims priority from Provisional Patent Application Ser. No. 60/666,352 filed Mar. 30, 2006. This Application is also related to U.S. patent application Ser. No. 10/913,749 titled “CAT CONDO” filed Aug. 6, 2004; the teachings of this application are incorporated herein by reference thereto.

### FIELD OF THE INVENTION

The present invention relates, in general, to an animal enclosure and, more specifically, this invention relates to a portable, collapsible animal enclosure used to contain a small pet in an outdoor environment.

### BACKGROUND OF THE INVENTION

There are many times that pet owners would like to take their pet outdoors but can't do so because of various types of weather conditions. Also, many pet owners are afraid to leave their pet outdoors unattended for fear that the animal may run away or that the pet will attract other animals and possibly be harmed by them.

Prior to the conception and development of the present invention, as is well known in the prior art, fenced in areas for pets to run are in widespread use. However, these fenced in runs are not enclosed and therefore do not provide any protection against the elements such as rain, wind, hale, etc. Furthermore, these type enclosures are relatively expensive and are clearly not portable.

Thus, it would be advantageous for a pet owner to have a shelter in which the pet may be placed which would not require supervision by the owner and yet the pet would be secure and still be able to enjoy being outdoors.

### SUMMARY OF THE INVENTION

According to a first aspect, the present invention provides a method of forming a pet enclosure for an outdoor area. Such pet enclosure is capable of being at least one of dismantled and collapsed into a relatively small package for storage when not in use. The method for forming this pet enclosure comprises the steps of providing a plurality of relatively straight pieces of pipe each having a first predetermined diameter and a predetermined length.

Providing a plurality of connectors each connector having a second predetermined diameter which is at least one of small enough to fit inside the pipe and large enough to receive the pipe therein. The connectors are selected to at least one of allow easy disassembly of the enclosure and folding up the enclosure into at least a partially collapsed state. There is an additional step of providing a framework for a door to allow entrance to the pet enclosure. There is another step of selecting a set of connectors to be used in assembling a framework for the pet enclosure and a step of assembling the plurality of relatively straight pieces of pipe into a framework including a framework for a roof for the pet enclosure using the set of connectors selected previously.

Another step includes attaching the framework for the door provided previously to the framework for the pet enclosure. Finally, the method includes providing a covering for the framework for the pet enclosure including the roof and the framework for the door.

In a second embodiment, the present invention provides a pet enclosure for an outdoor area. Such pet enclosure is capable of being easily dismantled into a relatively small package for storage when not in use. The pet enclosure includes a first plurality of relatively straight pieces of preselected structural members each having a first predetermined shape and a predetermined length and a plurality of connecting members. Each of the connecting members having a second predetermined shape which is at least one of being small enough to fit inside an end portion of one of the relatively straight pieces and large enough to receive the end portion of one of the relatively straight pieces therein. Additionally, the connectors are selected so as to allow easy disassembly and/or folding of the pet enclosure. There is a framework for a door engageable with at least one predetermined straight piece to allow entrance to the pet enclosure and a set of connectors to be used in assembling the framework for the door of the pet enclosure. There is a second plurality of relatively straight pieces of preselected structural members for forming a roof for the pet enclosure and a covering for the framework for the pet enclosure including the roof and the framework for the door.

In a third aspect, the present invention provides a pet enclosure for an outdoor area capable of being easily collapsed into a relatively small package for storage when not in use. The pet enclosure has a first plurality of relatively straight pieces of preselected structural members each having a first predetermined shape and a predetermined length and a plurality of connecting members each having a second predetermined shape which is at least one of small enough to fit inside an end portion of one of the relatively straight pieces and large enough to receive the end portion of one of the relatively straight pieces therein. The connectors are selected to allow collapsing of the pet enclosure.

There is a framework for a door engageable with at least one predetermined straight piece to allow entrance to the pet enclosure and a set of connectors to be used in assembling the framework for the door of the pet enclosure. There is a second plurality of relatively straight pieces of preselected structural members for forming a roof for the pet enclosure and a covering for the framework for the pet enclosure including the roof and the framework for the door.

### OBJECTS OF THE INVENTION

It is, therefore, one of the primary objects of the present invention is to provide an enclosure to contain a pet in an outdoor environment.

Another object of the present invention is to provide an enclosure for containing a pet in an outdoor environment which is portable.

Yet another object of the present invention is to provide an enclosure for containing a pet in an outdoor environment which is collapsible.

Still another object of the present invention is to provide an enclosure for containing a pet in an outdoor environment which will protect the pet from the sun.

Another object of the present invention is to provide an enclosure for containing a pet in an outdoor environment which will allow full air circulation.

Yet another object of the present invention is to provide an enclosure for containing a pet in an outdoor environment which is at least one of easily dismantled or collapsed for storage.

These and various other objects and advantages of the present invention will become more readily apparent to those person skilled in the relevant art from the following more detailed description, particularly, when such description is taken in conjunction with the attached drawings figures and with the appended claims.

### BRIEF DESCRIPTION OF THE DRAWINGS

FIG. 1 is a perspective view of the pet enclosure according to an embodiment of the present invention showing the underlying framework.

FIG. 2 is top view of the pet enclosure shown in FIG. 1 showing the shelf arrangement and the supporting members for the shelf.

FIG. 3 is a front view of the door member showing the attachment to the framework.

FIG. 4 is a perspective view from the front of a fully assembled pet enclosure showing the enclosure with the door closed according to an embodiment of the invention.

FIG. 5 is a perspective view of the completely assembled pet enclosure shown in FIG. 4 showing a cat occupying the lower level of the pet enclosure.

FIG. 6 is a perspective view of the completely assembled pet enclosure shown in FIG. 4 showing a cat occupying the upper level of the pet enclosure.

FIG. 7 is a perspective view of the side of the pet enclosure shown in FIG. 4.

FIG. 8 is a partial perspective view of a folding pet enclosure according to an alternate embodiment of the invention.

FIG. 9 is a front view of the pet enclosure shown in FIG. 8 in the folded condition.

FIG. 10 is a partial perspective side elevation view of the pet enclosure shown in FIG. 8 in the folded condition.

FIG. 11 is a partial perspective view for the disassembly of the pet enclosure according to yet another alternate embodiment of the invention.

FIG. 12 is a partial perspective view of the roof of the pet enclosure shown in FIG. 1 with an optional sun cover.

FIG. 13 is a top view of the sun cover shown in FIG. 12.

### BRIEF DESCRIPTION OF THE PRESENTLY PREFERRED AND ALTERNATE EMBODIMENTS OF THE INVENTION

Prior to proceeding with the more detailed description of the present invention it should be noted that, for the sake of clarity and understanding the salient features thereof, identical components which have identical functions have been designated by identical reference numerals throughout the several views illustrated in the drawings.

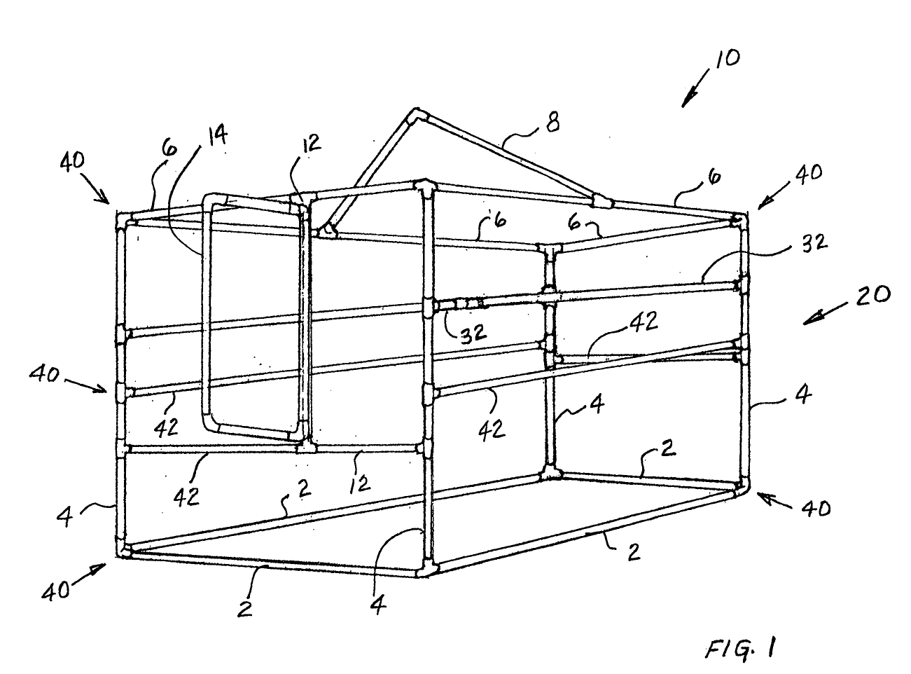

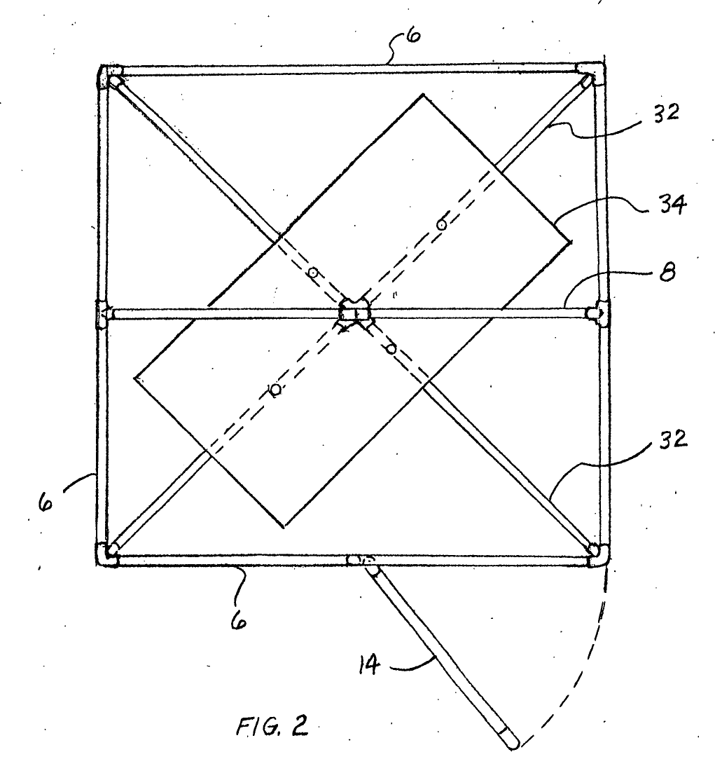

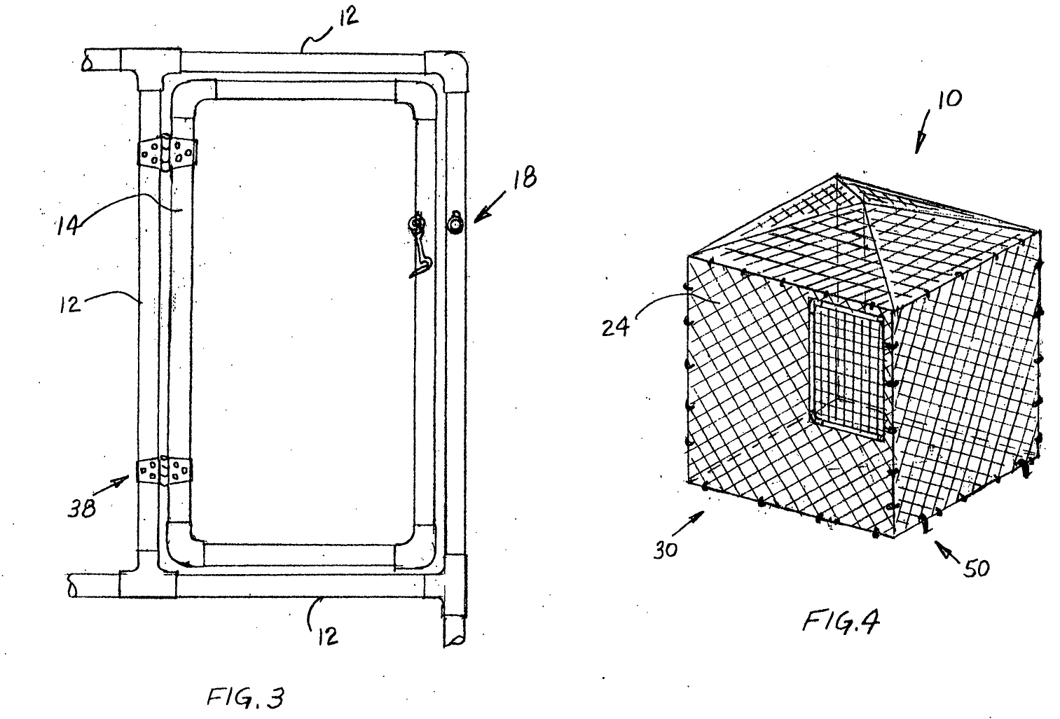

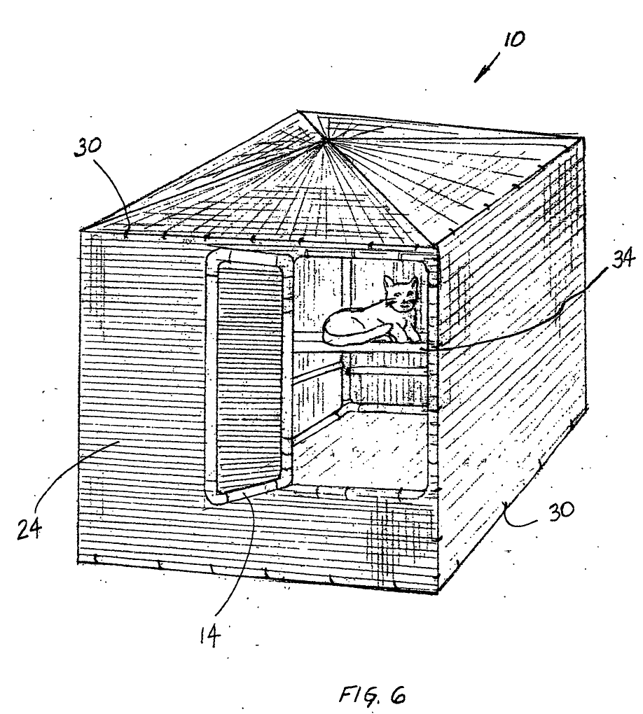

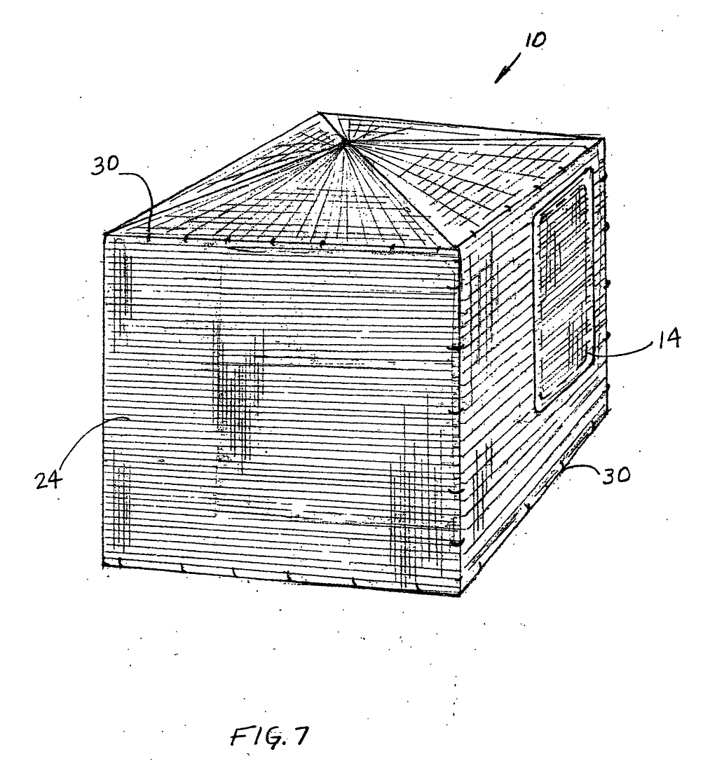

Reference is now made to FIGS. 1-7, illustrated therein is a pet enclosure, generally designated 10. Such pet enclosure 10 has a framework, generally designated 20, which has a predetermined configuration.

In a presently preferred embodiment on the invention, such configuration is generally rectangular and particularly being in the shape of a square or more specifically having a cubic shape. This is quite evident in FIG. 1. Although it is presently preferred that such framework 20 have a square or cubic configuration and most of the discussion will be related to that configuration it is within the scope of the invention that such shape could also be a different rectangular shape, a triangular or even a circular shape, substantially in the shape of an igloo.

The framework 20 has a first predetermined plurality of substantially horizontally disposed elongated rod like base members 2 that are engageable with one another to form a predetermined geometric shape. As mentioned previously it is preferred that such geometric shape be in the form of a square and thus the predetermined plurality of base members would be four.

Additionally, there is a predetermined plurality of substantially vertically disposed elongated rod like members 4, a first end of each of the vertically disposed elongated rod like members 4 is engageable substantially adjacent a respective end of the horizontally disposed elongated rod like base members 2. Again since the preferred shape of the pet enclosure is cubic there would also be four such substantially vertically disposed elongated rod like members 4 in the preferred embodiment.

Such framework 20 also includes a second predetermined plurality of substantially horizontally disposed elongated rod like members 6 that are engageable with an axially opposed second end of the vertical elongated rod like members 4. The second plurality of horizontally disposed elongated rod like members 6 are disposed in a plane that is substantially parallel to a plane that contains the first plurality of horizontally disposed elongated rod like base members 2.

Such framework 10 may also include various other horizontally disposed members 42 engageable with the vertical members to provide additional strength to the framework 20.

Further, the framework 10 has at least one elongated roof member 8 that has a predetermined configuration. Such elongated roof member 8 is engageable with the second plurality of horizontally disposed elongated rod like members 6. It is presently preferred that such roof member 8 be substantially in the shape of an inverted V.

The framework 20 also includes a door framework 12 that is disposed on at least one side of the pet enclosure 10. Such door framework 12 is disposed at a predetermined height. The door framework 12 is formed so as to include a portion of one of the vertically disposed elongated rod members 4 and also a portion of one of the substantially horizontally disposed elongated rod like members 6. The predetermined height is such that a bottom portion of door frame 12 disposed on the framework 20 is approximately 20 inches. Thus, the door frame 12 or the bottom of the door opening is about 20 inches above the ground level. This is an easy jump for a cat. Such door can be either a left side or a right side opening door.

There is a door member 14 that is disposed in the door framework 12. Such door member 14 is constructed of similar elongated rod members as is the rest of the framework 20. There is a means 38 that is disposed adjacent a first predetermined edge 16 of the door member 14 for securing the door 14 to the door framework 12. It is presently preferred that means 38 be strap like hinges.

The door member 14 also includes a locking means 18 that has a portion thereof connected to each of the door frame 12 and to the door 14 for securing the door member 14 in a closed position. This prevents the pet from accidentally pushing the door open and leaving the enclosure. It is presently preferred that such locking means 18 includes a spring loaded gate hook and an eye bolt to secure the door in a closed position.

The framework 20 of pet enclosure 10 includes an engagement means, generally designated 40, for connecting various members of the framework 20 to other members of the framework 20. It is presently preferred that such engagement means 40 includes tees and elbows. It is further presently preferred that such connections be made by friction fit so that the unit may be disassembled quite easily for storage.

There is a net like fabric material 24 which is used for covering the framework 20. Such net like fabric material 24 provides some shade, privacy and wind protection for the pet in the enclosure and basically forms the enclosure 10. The net like fabric 24 allows for free air circulation while protecting the pet from other animals and some weather conditions although not providing complete protection from rain.

Such net like material is selected from a group including nylon, polyethylene, polypropylene and metallic screen. It is presently preferred that such fabric is polyethylene. The present invention includes a means generally designated 30, for securing such net like fabric material 24 to the framework 20. It is presently preferred that such means 30 is one of nylon cable ties or PVC clips (snap clamps). The net like fabric 24 is wrapped around the framework 20 and is tied to the framework with these nylon cable ties 30. The net like fabric 24 covers the entire framework including the door.

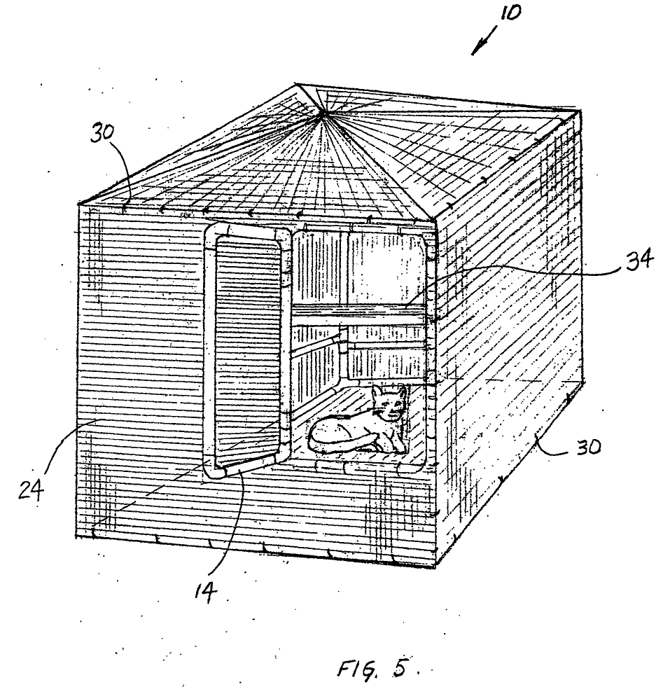

In an alternative embodiment of the invention, such pet enclosure 10 also includes a pair of crosspieces 32 that are engageable with a pair of radially opposed vertically disposed elongated rod like members 4. The pair of crosspieces 32 are disposed at substantially a midpoint on the substantially vertically disposed elongated rod like members 4. Crosspieces 32 are added to support a shelf member 34 which is mounted on the crosspieces 32. The shelf member 34 is added to permit such pets using the pet enclosure 10 to perch above the ground. With cats this is an important feature. It is also preferred that such shelf member 34 include carpeting, as is seen in FIGS. 4 and 5, to cover the shelf. It is further presently preferred that such carpeting be a carpet designed for outdoor use.

The invention also provides an optional ramp which can be used to access the shelf member 34. This would be an important feature for an aging pet or a pet which is not very agile to have access to the shelf.

In a presently preferred embodiment of the invention, such framework 20 is formed from a similar material. Such material is selected from a group of materials including polyvinyl chloride, acrylonitrile butadiene styrene polymer (ABS), polypropylene, chlorinated polyvinyl chloride (CPVC) and polyethylene. It is presently preferred that such material is polyvinyl chloride. It is also presently preferred that such framework 20 be constructed of tubular sections of such polyvinyl chloride. Polyvinyl chloride is preferred because not only is it relatively strong and yet relatively inexpensive but it is quite easy to work with.

Such pet enclosure 10 also includes a means, generally designated 50, for securing the pet enclosure to one of the ground, patio and porch to ensure that such pet enclosure remains securely in place. Such securing means 50 includes stakes, for securing the enclosure 10 to the ground and brackets, ropes or wire for securing such enclosure 10 to a porch or patio. The pet enclosure 10 can accommodate at least several pets. The shelf member 34 is large enough for at least two cats.

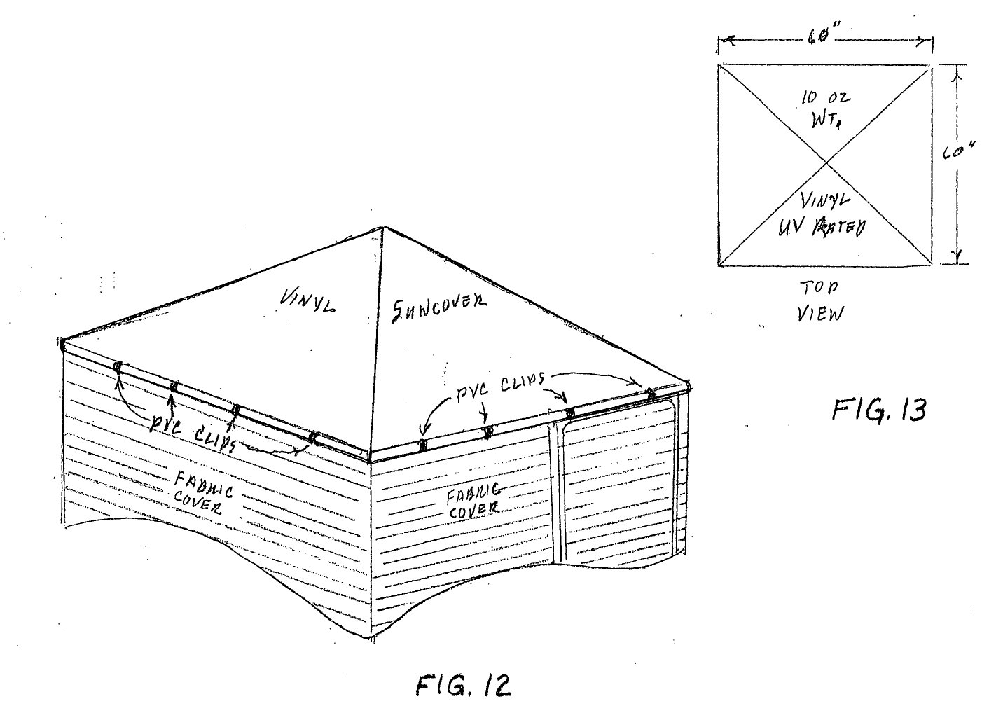

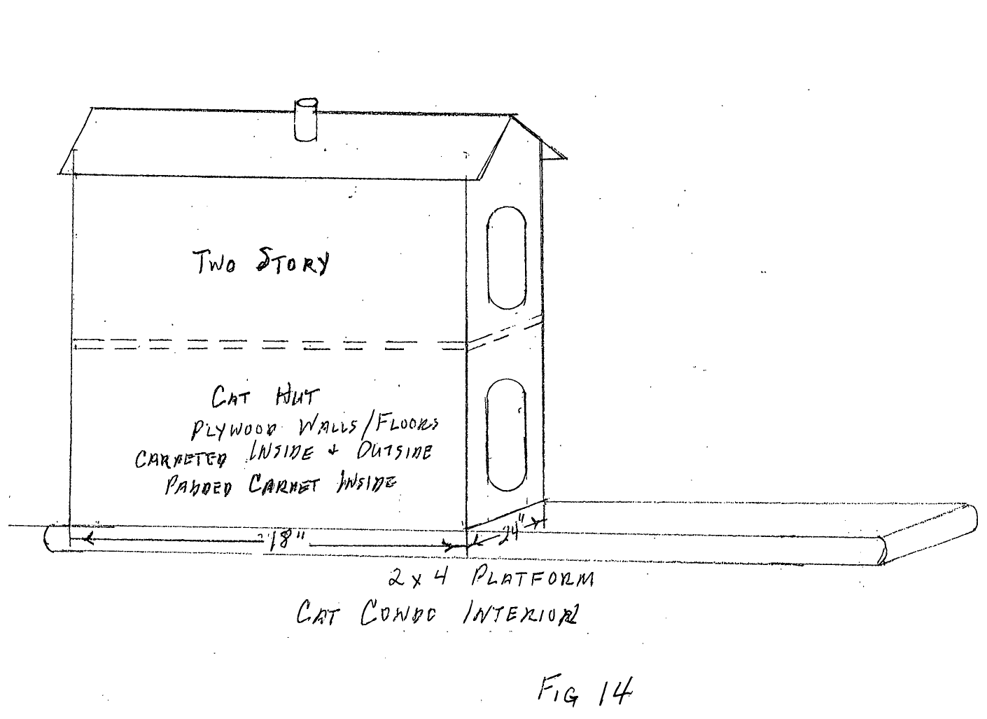

There is an optional sun cover, illustrated in FIG. 12, which can be mounted over the roof of the pet enclosure so as to provide shade for the pet and also some protection from the rain. The sun cover is mounted by means of PVC clips. It is presently preferred that such sun cover be made of vinyl, such as a polyester vinyl laminated fabric.

FIG. 11 illustrates an alternate embodiment of the invention wherein such pet enclosure is constructed so that it can be partially disassembled quite easily for storage. It is recommended that two persons disassemble the enclosure; however, one person can do the partial disassembly with some diligence. The enclosure will be compactly disassembled into one horizontal plane to six inches deep for seasonal storage. The fabric cover or optional sun roof do not need to be removed. However, prior to disassembly the optional ramp, if used, must be removed first.

The steps to be followed in such disassembly are:

1. Remove stakes, clamps or ropes holding the enclosure to the ground, porch or patio. Place the stakes, clamps or ropes inside a plastic bag.

2. Lay the enclosure on the back side (not the door side) on any grassy area (not rocky) to gain entry. It is satisfactory to step on fabric with rubber sole shoes.

3. Remove the four screws in the (S) and (V) tees (see, FIG. 11) holding the platform pipes in place. Retain the screws in a plastic bag for safekeeping.

4. Either pull or tap lightly with a hammer at the connections of (S) and (V) tees to separate the (H) and (I) pipes from these connections. After all four ends have been disconnected, pull the entire platform assembly from the enclosure. Lay the platform outside the enclosure. Tie or tape the bag with the screws to the platform. Wrap plastic and tape the ends of the platform pipes for fabric protection.

5. Either pull or tap lightly with a hammer at the connections of (R), (S), (T) and (V) to separate the bottom and middle (A) pipes of the two left and two right sections of the enclosure. Lay these pipes outside the enclosure.

6. Either pull or tap lightly with a hammer at the (R) connections at the top to separate (L) pipes on both sides of the enclosure.

7. Either pull or tap lightly with a hammer at the (T) connections of the roof assembly to separate the (M) and (Y) domed section from these connections. Lay the (M) and (Y) roof assembly outside the enclosure.

8. A second person may be required to hold up the collapsed unit for inserting the loose items for storage. One person could do this by using a box or similar item to prop up the top part of the enclosure in the center of each side to about two or three feet high. This should provide enough room to insert the disassembled items.

9. Insert the disassembled pipes into a large 20 gallon trash bag or equivalent and lay the bag at an angle on the back side of the collapsed enclosure.

10. Carefully insert the platform assembly over the bagged disassembled pipes. Some juggling may be required to get the platform to fit inside. Tie or tape the bag containing the stakes, clamps or rope removed in step (1) inside the enclosure. If the enclosure had the cat ramp, insert the cat ramp inside the unit also for storage.

11. Either collapse the unit or pull the two props to collapse the enclosure. Tie the enclosure together with some rope around the entire unit.

12. Transport the enclosure to your storage location. Due to its size, two people may be required to transport the enclosure.

13. It is not recommended that the unit be hung directly on a hook in the storage area as the hook can damage the fabric. It is recommended that the existing rope used to tie the enclosure be used for hanging the unit or lay the unit against the wall or place the unit on an overhead shelf.

14. For reassembly, simply reverse the previous steps. The partial disassembly of the enclosure as described above should only require about one half hour by following the simple directions that were enumerated.

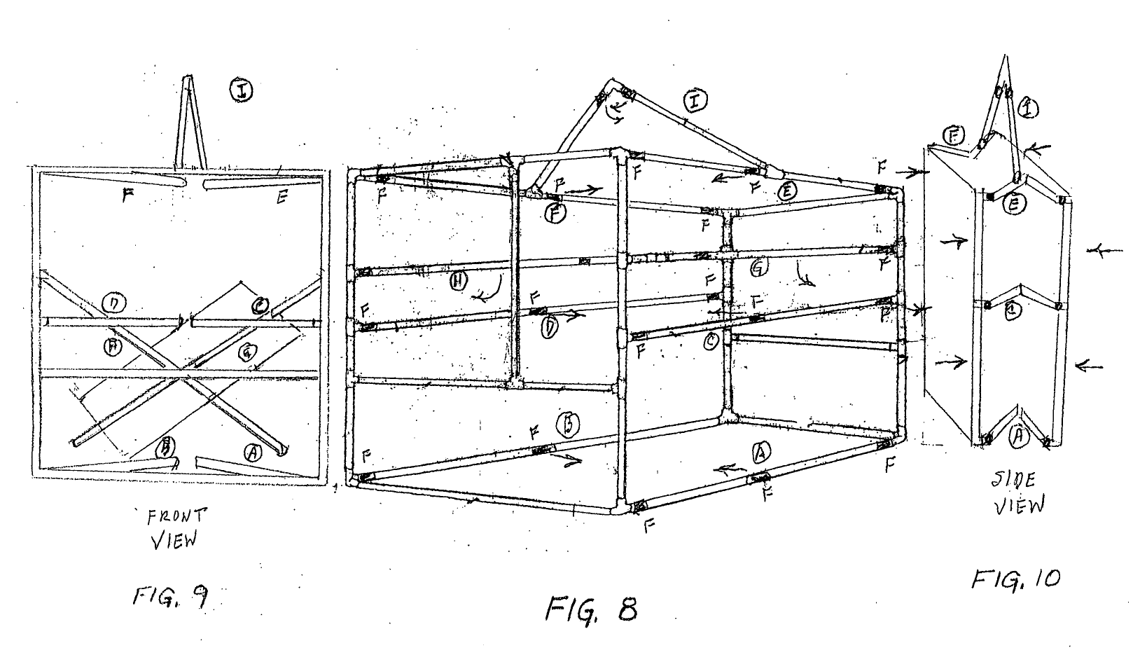

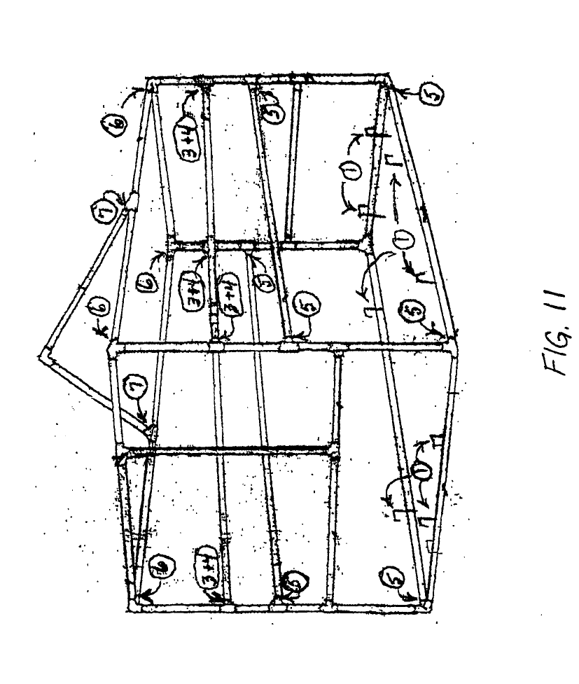

In still another embodiment of the invention, as seen in FIGS. 8,9, and 10 the unit can be constructed utilizing folding joint connectors at key locations that are adapted to fold so the enclosure may be compacted to about a ten inch wide unit quite easily without disassembling any members. In this embodiment the enclosure can be reassembled very quickly. The folding of this enclosure only requires that the folding joint connectors (F) shown clearly in FIG. 8 be folded and then the enclosure can be folded to a relatively compact unit as seen in FIGS. 9 and 10. Again, as with the disassembly described above if a ramp is included the ramp must be removed before the folding is started.

While both the presently preferred and a number of alternative embodiments of the present invention have been described in detail above it should be understood that various other adaptations and modifications of the present invention can be envisioned by those persons who are skilled in the relevant art without departing from either the spirit of the invention or the scope of the appended claims.

I claim:

1. A method of forming a pet enclosure for an outdoor area, said pet enclosure being capable of at least one of dismantled and collapsed into relatively a relatively small package for storage when not in use, said method comprising the steps of:
(a) providing a plurality of relatively straight pieces of pipe each having a first predetermined diameter and a predetermined length;
(b) providing a plurality of connectors each having a second predetermined diameter which is at least one of small enough to fit inside said pipe and large enough to receive said pipe therein, said connectors being selected to one of allow easy disassembly and folding up into at least a partially collapsed state;
(c) providing a framework for a door to allow entrance to said pet enclosure;
(d) selecting a set of connectors to be used in assembling a framework for said pet enclosure;
(e) assembling said plurality of relatively straight pieces of pipe into said framework including a framework for a roof for said pet enclosure using said set of connectors selected in step (d);
(f) attaching said framework for said door provided in step (c) to said framework for said pet enclosure assembled in step (e); and
(g) providing a covering for said framework for said pet enclosure including said roof and said framework for said door.

2. A pet enclosure for an outdoor area, said pet enclosure capable of being easily dismantled into a relatively small package for storage when not in use, said pet enclosure comprising:
(a) a first plurality of relatively straight pieces of preselected structural members each having a first predetermined shape and a predetermined length;
(b) a plurality of connecting members each having a second predetermined shape which is at least one of being small enough to fit inside an end portion of one of said relatively straight pieces and large enough to receive said end portion of one of said relatively straight pieces therein, said connectors being selected to allow easy disassembly of said pet enclosure;
(c) a framework for a door engageable with at least one predetermined straight piece to allow entrance to said pet enclosure;
(d) a set of connectors to be used in assembling said framework for said door of said pet enclosure;
(e) a second plurality of relatively straight pieces of preselected structural members for forming a roof for said pet enclosure; and
(f) a covering for said framework for said pet enclosure including said roof and said framework for said door.

3. A pet enclosure for an outdoor area, said pet enclosure capable of being easily collapsed into a relatively small package for storage when not in use, said pet enclosure comprising:
(a) a first plurality of relatively straight pieces of preselected structural members each having a first predetermined shape and a predetermined length;
(b) a plurality of connecting members each having a second predetermined shape which is at least one of being small enough to fit inside an end portion of one of said relatively straight pieces and large enough to receive said end portion of one of said relatively straight pieces therein, said connectors being selected to allow collapsing of said pet enclosure;
(c) a framework for a door engageable with at least one predetermined straight piece to allow entrance to said pet enclosure;
(d) a set of connectors to be used in assembling said framework for said door of said pet enclosure;
(e) a second plurality of relatively straight pieces of preselected structural members for forming a roof for said pet enclosure; and
(f) a covering for said framework for said pet enclosure including said roof and said framework for said door.

4. The pet enclosure, according to claim 3, wherein said plurality of said connecting members includes a plurality of folding joint connectors for use in predetermined connections.

5. The pet enclosure, according to claim 3, wherein said plurality of said folding joint connectors are used in horizontal side pieces of said framework.

6. The pet enclosure, according to claim 3, wherein said plurality of said folding joint connectors are used in both pieces of said second plurality of relatively straight pieces of preselected structural members for forming a roof for said pet enclosure.
